(19) United States
(12) Patent Application Publication
(10) Pub. No.: US 2012/0138218 A1
(43) Pub. Date: Jun. 7, 2012

(54) RAPID MATERIAL PLACEMENT APPLICATION FOR WIND TURBINE BLADE MANUFACTURE

(75) Inventors: Jay M. Dean, West Bend, WI (US); John H. Hawthorne, Loves Park, IL (US); William J. McCormick, Mukwonago, WI (US)

(73) Assignee: MAG IAS, LLC, Sterling Heights, MI (US)

(21) Appl. No.: 13/318,910

(22) PCT Filed: May 4, 2010
(86) PCT No.: PCT/US10/33459

§ 371 Date: Dec. 7, 2011

(30) Foreign Application Priority Data
May 4, 2009 (US) 61175257

(51) Int. Cl. B29C 70/18

(52) U.S. Cl. 156/243; 156/538

(57) ABSTRACT

An apparatus is disclosed for charging molds used to mold wind turbine blades in which the molds have a root end and a tip end. The apparatus includes a first and second gantries located at the root end of the mold and capable of moving to the tip end of the mold. A layup end effector on the first gantry receives a length of reinforcing ply material and temporarily stores the ply material on the layup end effector. A clamping end effector mounted on the second gantry has a clamping board that is shaped to fit the root end of the mold. The clamping end effector grips the end of the ply material temporarily stored on the layup end effector secures the end of the ply material to the root end of the mold while the first gantry lays the ply material in the mold.

### FIELD

The described device relates to an automated process and apparatus for charging wind turbine blade molds.

### BACKGROUND

The commercial demand for wind turbine blades steadily increases as the cost of power generation continues to rise. Wind turbine blades range in size from twenty to sixty meters in length and are generally formed from glass or carbon fiber reinforced resin. The blades are hollow and are formed in two halves, an upwind half and a downwind half that splits the blade along the longitudinal axis. Once the blade halves have been formed on molds and cured, the two halves are fastened together with adhesive to form the finished blade.

Blade manufacture and the process of charging the molds is largely a manual process. The two blade halves are formed in side-by-side molds so that the resulting halves can be mated together with a minimum amount of movement required. A gel coat is first sprayed into the mold halves. Reinforcing fibers such as glass, carbon fibers or aramid fibers are then placed into the mold halves. The fibers may be woven into a cloth-like fabric, in which case the fabric has to be correctly positioned in the mold halves. Because the cross section of the finished blades is not a cylinder, and the circumference of the blades changes from the root end to the tip, the cloth reinforcing material has to be cut to the correct shape prior to being placed in the molds. Typical blades are forty meters in length, so positioning the reinforcing cloth in the molds can be a cumbersome and time consuming process. If the cloth is placed along the length of the blade, a forty meter length of cloth is required, and cutting the cloth to the proper taper for fitting the cloth to the edges of the mold is a difficult task. If the cloth is placed across the width of the blade, care must be taken where the edges of adjacent cloth pieces come together so that the resulting laminate structure does not have gaps in the reinforcing cloth, or does not have overlapping areas of cloth that would increase the thickness of the resulting laminate beyond acceptable tolerances. After the reinforcing materials have been properly located in the mold halves, resin is applied to the fibers and the two molded blade halves are allowed to cure. Once the cure is complete, adhesive is applied to the interior of the blade for core pieces and shear webs that will be mounted in the blade, and those elements are added to the blade. Adhesive is applied to the edges of at least one of the blade halves and to the top surfaces of the core pieces and the shear webs. The two molded halves are then brought together, usually by lifting and placing the half without the adhesive (the moving half) onto the half with the adhesive (the resting half). After the adhesive cures, the resulting complete blade can be removed from the mold holding the resting half.

It would be desirable to decrease the amount of manual labor required to charge a wind turbine blade mold and to manufacture a wind turbine blade as discussed above. It would further be desirable to mechanize the application of gel coat to the mold halves. It would also be desirable to mechanize the placement of fiber reinforcement material into the mold halves in the manufacture of wind turbine blades. It would further be desirable to mechanize the application of adhesive to the edges of the two blade halves prior to joining the two blade halves together. It would additionally be desirable to mechanize the placement of the moving blade half onto the resting blade half in order to form the completed wind turbine blade.

### BRIEF DESCRIPTION OF THE DRAWINGS

FIG. 1 is a perspective view of an installation for molding wind turbine blades.

FIG. 2 is a side view of a ply generator positioned in front of a multi-roll magazine of reinforcing material.

FIG. 3 is a perspective view of a layup end effector.

FIG. 4 is an overhead perspective view of the layup gantries and the clamping gantries positioned at the root end of the mold halves.

FIG. 5 is a detail view of a clamping end effector.

FIG. 6 is a detail view of the end effectors used for gel coat and adhesive dispensing.

FIG. 7 shows a gel coat dispenser head positioned in the mold cavity.

FIG. 8 shows adhesive dispensing heads positioned on the edges of a molded part.

FIG. 9 shows powered hinge units being used mate two molded blade halves together.

### DESCRIPTION

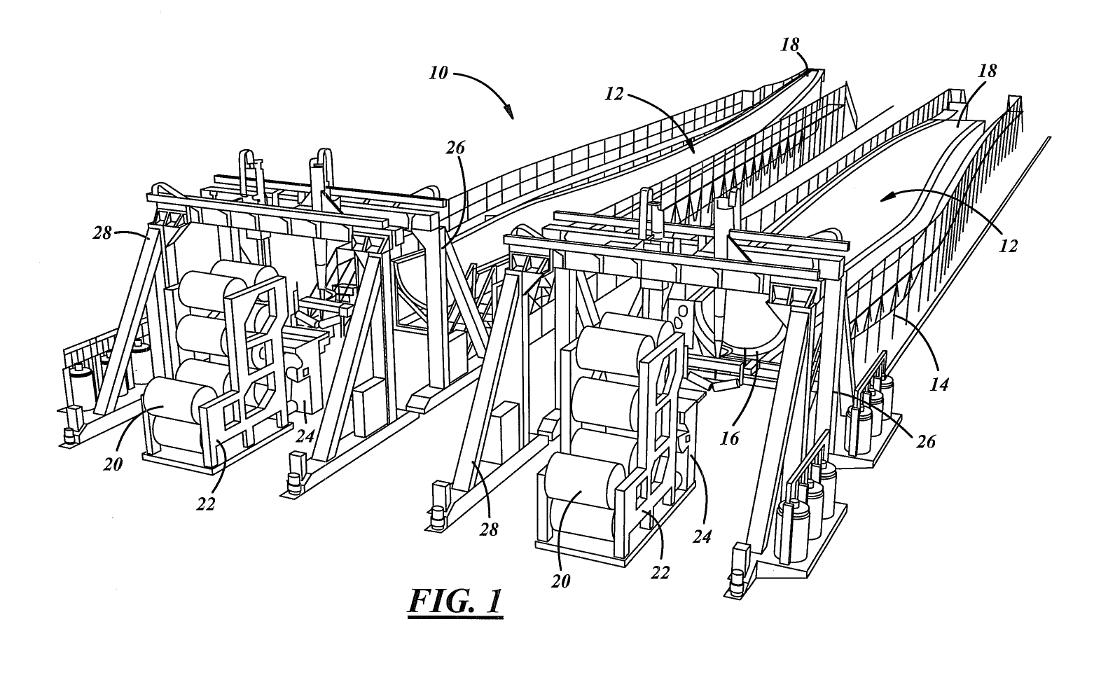

Turning now to the drawing figures, FIG. 1 shows an installation for molding two wind turbine blades generally designated by the reference numeral 10. Two elongated mold halves 12 are used for molding wind turbine blades and are positioned longitudinally side-by-side. Each mold half 12 is held by a supporting frame 14 so that the concave surface of the mold half is facing upward. Each mold half is positioned with the root end 16 of the mold, the end that will mold the portion of the blade that attaches to the hub, in the foreground of the drawing, and the tip end 18 of the mold, the end that will mold the tip portion of the blade, in the background of the drawing. Several rolls 20 of reinforcing ply material in different widths and in different weaves and composition are located in a multi-roll magazine 22 that is positioned adjacent to a ply generator 24 at the root end of the mold. Plies of fiber reinforcing material are generated at the ply generator 24, and the plies are robotically placed in the molds 12 as described more fully below. Two gantries 26 and 28 are located at the root end 16 of each mold. The two gantries 26 and 28 are independently movable along the length of the mold, and are used to carry out different operations during the molding cycle.

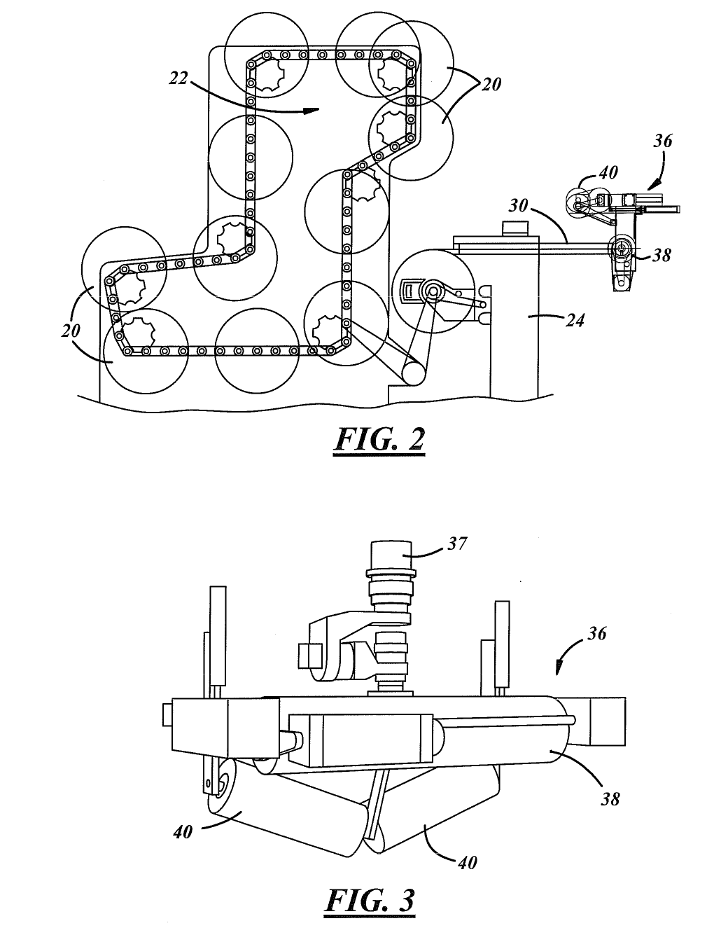

FIG. 2 shows the ply generator 24 that is positioned between the magazine 22 that carries the rolls 20 of reinforcing material and the root end 16 of the mold. The ply generator 24 selects the correct material from the rolls 20 of material, cuts the material to the desired shape, and uses a ply delivery conveyor 30 to deliver the ply material to a robotic end effector 36 for automated placement in the mold as described more fully below. The layup end effector 36 has a layup spool 38 that is used to spool up the ply material that is generated by the ply generator 24. The end effector 36 may be rotated about a vertical axis to position the layup spool 38 in a position to receive material from the ply delivery conveyor 30 as shown. The layup spool 38 has a gripping mechanism (not shown) that grips the end of the ply and winds it onto the layup spool.

FIG. 3 is a perspective view of the layup end effector 36. The end effector 36 is mounted on the end of a robot arm 37, and includes a layup spool 38 and a pair of powered brushes. In use, after the layup spool 38 has received a length of ply material from the ply conveyor 30, the end effector 36 is rotated about the vertical axis to orient the layup spool in a position to deliver ply material into the mold 12. After the end of the ply material is clamped in place in the mold by the clamping end effector 34 as described below, then the layup gantry 26 travels from the root end 16 of the mold to the tip end 18, and the ply material is unwound from the layup spool 38 and laid into the mold. The powered brushes 40 are used to press the ply material from the layup spool 38 into the mold 12, and to smooth the material onto the mold surface.

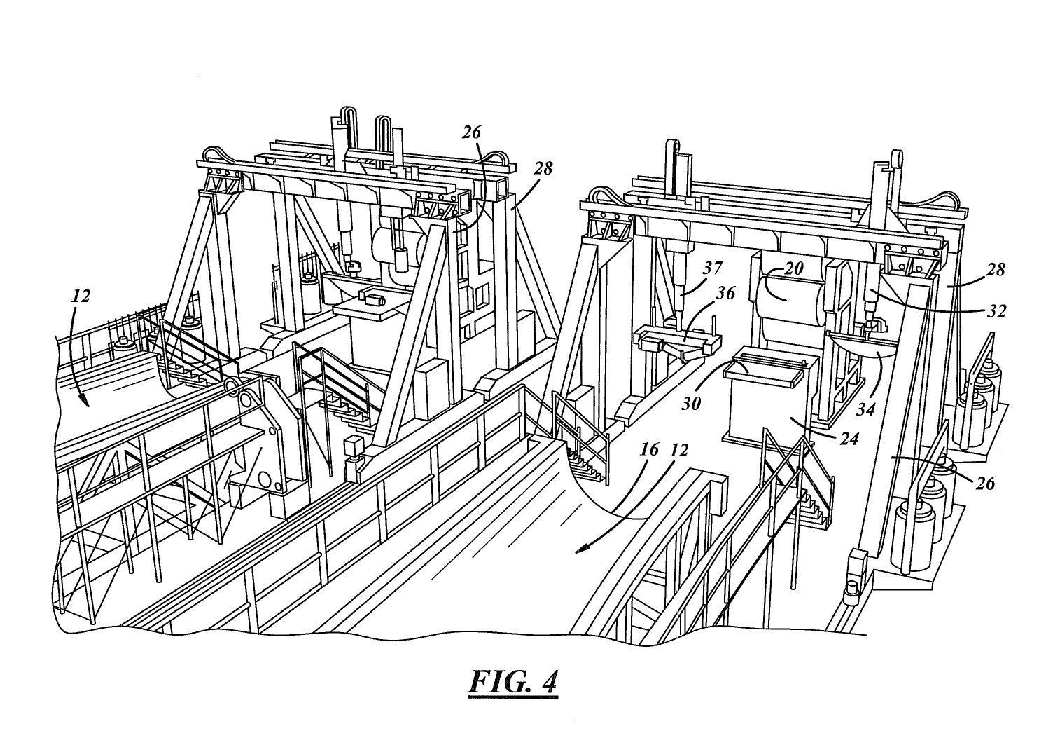

FIG. 4 is an overhead perspective view from the mold 12 toward the two gantries 26 and 28 at the root end of the mold. The lay-up gantry 26 is closest to the mold 12 and the clamping gantry 28 is next to the magazine 24 that holds the rolls 20 of reinforcing ply material. The clamping gantry 28 supports a robot arm 32 with a clamping end effector 34 that is designed to anchor the ply material at its starting point in the mold as described below. The clamping end effector 34 is used to grip the end of the reinforcing material that has been wound onto the spool 38 of the lay-up gantry, and to clamp the end of the reinforcing material against the root end 16 of the mold as the reinforcing material is spooled from the lay-up gantry 26 into the mold.

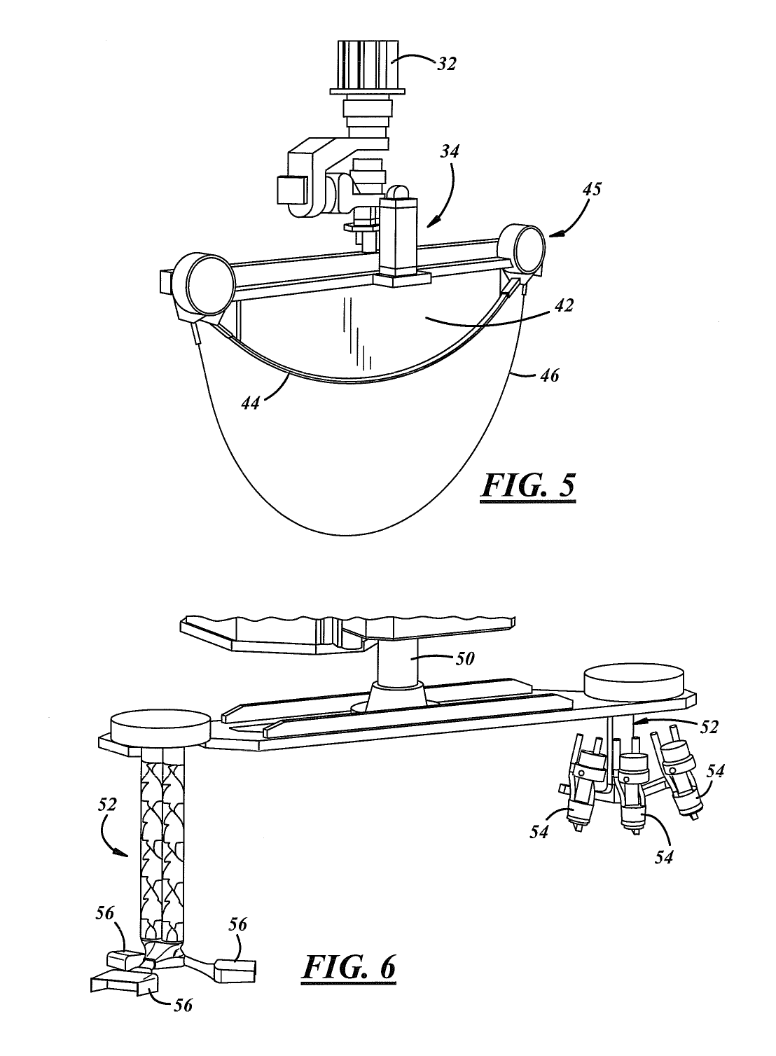

FIG. 5 shows in detail the clamping end effector 34 that is carried by the clamping gantry. The clamping end effector 34 has a forming board 42 with a lower surface 44 that is shaped to fit into the interior of the root end 16 of the mold. A powered clamp 45 uses a band 46 that can be tightened around the lower surface 44 the forming board 42 to clamp the end of a ply against the forming board. Once the ply material is clamped against the forming board 42, the clamping gantry 28 then moves to position the forming board 42 over the root end 16 of the mold, and the robot arm 32 that supports the end effector 34 lowers the forming board until it comes into contact with the root end 16 of the mold. This clamps the end of the ply material in place in the root end 16 of the mold. The lay-up gantry 26 then travels from the root end 16 to the tip end 18 of the mold, laying the ply from the layup spool 38 in place in the mold cavity. As the lay-up gantry 26 travels to the tip end 18 of the mold, the powered brushes 40 may be used to press the ply material down onto the mold surface, and to smooth out any wrinkles in the ply material.

The clamping gantry 28 remains at the root end of the mold as the layup gantry 26 travels from the root end 16 to the tip end 18 of the mold. After the ply has been laid along the length of the mold, the clamp band 46 is released from the forming board 42 and the ply material is freed from the clamp 45 by moving the forming board 42 away from the root end of the mold until the end of the ply is no longer held by the clamp band 46. The clamp band 46 is then expanded and moved to a point where the next ply that will be laid into the mold is spooled. The end of the next ply is gripped against the forming board 42 by the clamping band 46, the forming board 42 is lowered to the desired location in the mold to position the ply in the mold, and the process of laying the material into the mold is repeated.

Both gantries 26 and 28 are capable of travel along the length of the molds 12 during the molding process. Both gantries 26 and 28 can be equipped with a Z-axis robot arm 50 as shown in FIG. 6 with end effectors 52 equipped with spray heads 54 for applying gel coat to the mold halves, and with applicators 56 for applying adhesive to the interior surface or to the edges of the molded blade halves as may be required by the blade manufacturing process. The adhesive applicators 56 may be different sizes for applying different width adhesive stripes to the mold halves as desired. The use of the two gantries 26 and 28 to apply gel-coat to the mold halves during the molding process, or adhesive to the edges of the molded blade halves before the halves are mated together to form a complete blade reduces the amount of time required to perform these operations.

Each robot arm 50 may include a standard tool change mechanism (not shown) mounted to the Z-axis housing. During gel-coat operations, the adhesive applicators 56 will be secured in a receptacle on the tool changer, and during adhesive dispensing operations, the gel coat spray heads 54 will be secured in a receptacle on the tool changer. Other tools may be provided for deployment by the tool changer mechanism as desired.

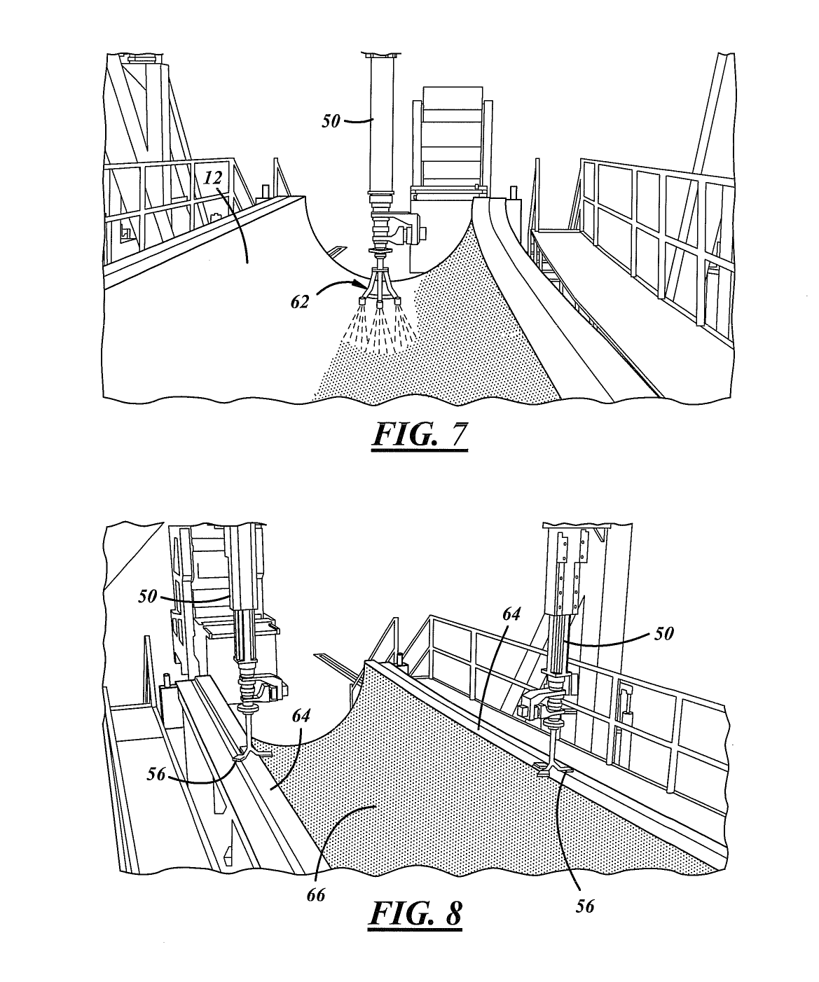

FIG. 7 shows a robot arm 50 with an end effector 62 used for mold preparation prior to molding. The end effector 62 may be used to apply a coating such as a gel-coat to the interior surface of the mold 12. Each end effector may be provided with a bulk supply system (not shown) for coatings, resins, adhesives and other materials that may be used during the blade manufacturing process. The end effectors 62 may have interchangeable spray heads for the particular material that is being applied to the mold.

FIG. 8 shows the robot arm 50 with adhesive applicators 56 being used to apply adhesive to the edges 64 of the molded blade half 66 prior to the half being mated to the other half to form a complete blade. As shown, two robot arms 50 may be used simultaneously to apply adhesive to the two edges 64 of the molded blade half 66 to reduce the amount of time required to complete the operation.

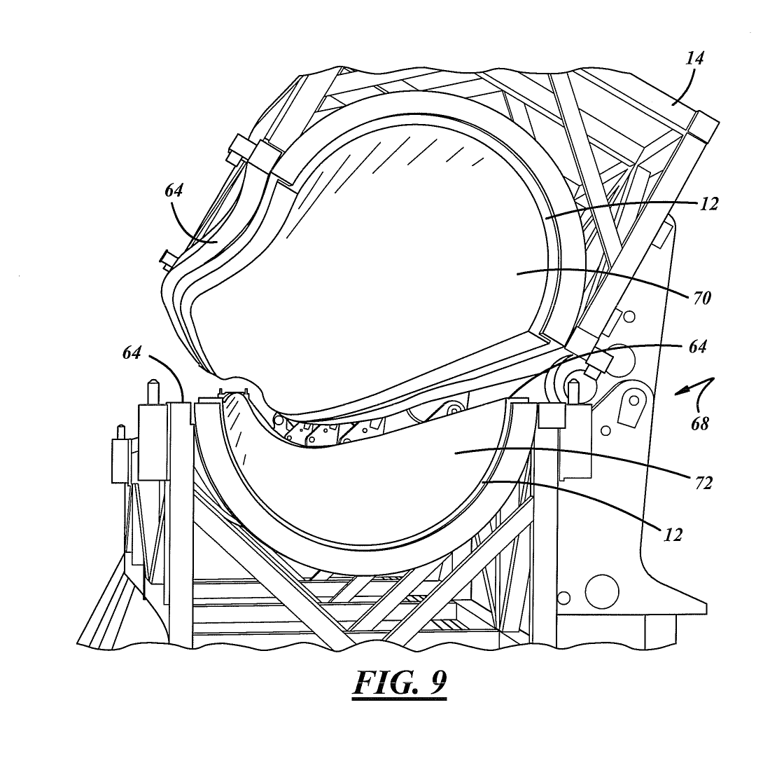

As shown in FIG. 9, after adhesive has been applied to the mating surfaces 64 of the two molded blade halves 66, powered hinge units 68 may be provided to flip the moving half 70 of the molded blade onto the resting half 72 to form a complete blade.

Having thus described the invention, various modifications and alterations will occur to those skilled in the art, which modifications and alterations will deemed to be within the scope of the invention as defined by the appended claims.

1. An apparatus for charging molds used to mold wind turbine blades, the molds having a root end and a tip end, the apparatus comprising:
a first gantry located at the root end of the turbine blade mold and capable of moving to the tip end of the mold;
a source of reinforcing ply material for charging the molds;
a layup end effector on the first gantry for receiving a length of ply material from the from the source of reinforcing ply material and temporarily storing the length of ply material on the end effector; the layup end effector laying the length of ply material along the mold as the gantry moves along the length of the mold.

2. The apparatus of claim 1 further comprising:
a second gantry located at the root end of the mold;
a clamping end effector mounted on the second gantry for gripping the end of the ply material temporarily stored by the layup end effector; and
the clamping end effector having a clamping board that is shaped to fit the root end of the mold; whereby the clamping end effector secures the end of the ply material to the root end of the mold while the first gantry lays the ply material in the mold.

3. The apparatus of claim 2 further comprising:
first dispensing end effectors mounted on at least one of the gantries, the first dispensing end effector selectively dispensing gel-coat onto the mold.

4. The apparatus of claim 3 further comprising:
second dispensing end effectors mounted on at least one of the gantries, the second dispensing end effectors selectively dispensing adhesive onto the molded product in the mold.

5. The apparatus of claim 1 further comprising:
at least one brush carried by the layup end effector, the brush being mounted on the end effector to press the material down and smooth it onto the mold surface as the end effector lays the material into the mold.

6. The apparatus of claim 2 further comprising:
a clamp band mounted on the clamp board, the clamp band being used to grip the end of the ply material against the forming board and to place the end of the ply material at the starting point for the ply material in the mold.

7. The apparatus of claim 1 further comprising:
a ply generator at the root end of the turbine blade mold; and,
at least one roll of fabric for supplying fabric to the ply generator; the ply generator and the roll of fabric comprising the source of reinforcing ply material for charging the molds.

8. The apparatus of claim 7 further comprising:
a plurality of rolls of ply material for charging the molds; and,
a magazine for containing the plurality of rolls.

9. The apparatus of claim 1 wherein the layup end effector lays the ply material along the mold as the gantry moves from the root end to the tip end of the mold.

10. A process for charging molds used to mold wind turbine blades, the molds having a root end and a tip end, the process comprising the steps of:
positioning a first gantry at the root end of the turbine blade mold;
supplying a length of ply material to a layup end effector on the first gantry from a source of ply material;
temporarily storing the length of ply material on the layup end effector;
moving the gantry along the length of the mold; and,
laying the length of ply material from the layup end effector into the mold as the gantry moves along the length of the mold.

11. The process of claim 10 further comprising the steps of:
positioning a second gantry located at the root end of the mold;
gripping the end of the ply material temporarily stored by the layup end effector by a clamping end effector mounted on the second gantry;
providing a clamping board on the second end effector that is shaped to fit the root end of the mold;
clamping the end of the ply material against the clamping board; and
lowering the clamping board into contact with the interior surface of the mold, whereby the clamping end effector secures the end of the ply material in the mold while the first gantry lays the ply material in the mold.

12. The process of claim 11 further comprising the steps of:
providing first dispensing end effectors mounted on at least one of the gantries; and,
selectively dispensing gel-coat onto the mold using the first dispensing end effectors.

13. The process of claim 12 further comprising the steps of:
providing second dispensing end effectors mounted on at least one of the gantries; and,
selectively dispensing adhesive onto the molded product in the mold using the second dispensing end effectors.

14. The process of claim 10 further comprising the steps of:
mounting at least one brush on the layup end effector; and,
pressing the material down and smoothing it onto the mold surface with the brush as the end effector lays the material into the mold.

15. The process of claim 11 further comprising the steps of:
providing a clamp band on the clamp board; gripping the end of the ply material against the forming board using the clamp band; and,
placing the end of the ply material at the starting point for the ply material in the mold using the clamp board.

16. The process of claim 10 further comprising the steps of:
providing a ply generator at the root end of the turbine blade mold; and,
supplying fabric to the ply generator from at least one roll of fabric, whereby the ply generator and the roll of fabric comprises the source of reinforcing ply material for charging the molds.

17. The process of claim 10 further comprising the step of:
laying the ply material along the mold with the layup end effector as the gantry moves from the root end to the tip end of the mold.
